(19) United States
(12) Patent Application Publication
(10) Pub. No.: US 2002/0064689 A1
(43) Pub. Date: May 30, 2002

(54) Magnetic recording medium and magnetic recording apparatus

(75) Inventors: Hideaki Yamanaka, Toride-shi (JP); Nobuyuki Inaba, Hasuda-shi (JP); Tetsunori Koda, Kitasouma-gun (JP); Enji Fujita, Kitasouma-gun (JP); Satoshi Matsunuma, Kamakura-shi (JP); Teruaki Takeuchi, Kitasouma-gun (JP)

Correspondence Address: OLIFF & BERRIDGE, PLC, P.O. BOX 19928, ALEXANDRIA, VA, 22320, US

(73) Assignee: Hitachi Maxell, Ltd., Ibaraki-shi (JP)

(21) Appl. No.: 09/944,193

(22) Filed: Sep. 4, 2001

(30) Foreign Application Priority Data
Nov. 27, 2000 (JP) 2000-359200
Feb. 28, 2001 (JP) 2001-054254
Mar. 19, 2001 (JP) 2001-078630

(51) Int. Cl. G11B 5/66

(52) U.S. Cl. 428/694 TM

(57) ABSTRACT

An in-plane magnetic recording medium comprises, on a substrate, a first underlying base layer of NiAl, a second underlying base layer of CrMo, a ferromagnetic atom-rich layer of CoPt, a magnetic coupling layer of Ru, a recording layer of CoCrPtB, and a protective layer of carbon. The magnetic coupling layer brings about exchange coupling force between the recording layer and the ferromagnetic atom-rich layer. The ferromagnetic atom concentration is high in the ferromagnetic atom-rich layer as compared with the recording layer. Therefore, the exchange coupling force, which is exerted between the ferromagnetic atom-rich layer and the recording layer, is remarkably improved. Accordingly, it is possible to provide a magnetic recording apparatus which is excellent in recording stability over a long period of time in which the thermal stability of the magnetic recording medium is excellent.

### BACKGROUND OF THE INVENTION

1. Field of the Invention

The present invention relates to a magnetic recording medium and a magnetic recording apparatus. In particular, the present invention relates to an in-plane magnetic recording medium which is excellent in thermal stability and which is preferable for high density recording, and a magnetic recording apparatus which is installed with the in-plane magnetic recording medium.

2. Related Art

Recent progress of the advanced information society is remarkable. The multimedia, with which not only the character information but also the voice and image information can be processed at a high speed, are popularized. A magnetic recording apparatus, which is installed to a computer or the like, is known as one of the multimedia. At present, the development is advanced in order that the magnetic recording apparatus is miniaturized while improving the recording density of such a magnetic recording apparatus.

A typical magnetic recording apparatus includes a plurality of magnetic disks which are rotatably installed onto a spindle. Each of the magnetic disks comprises a substrate and a magnetic film formed thereon. Information is recorded by forming a magnetic domain having a specified magnetization direction in the magnetic film.

In order to realize the high density recording with the magnetic recording apparatus as described above, it is demanded that the diameter of grains for constructing the magnetic film is made fine and minute and the interaction between the respective grains is lowered. However, a problem arises such that the thermal stability of the grains is lowered if the grain diameter is made fine and minute and the interaction between the grains is lowered.

The known technique for improving the thermal stability of the magnetic disk, especially a magnetic disk having magnetization in the in-plane direction include a method in which a so-called keeper layer having soft magnetization is provided as an underlying base layer for a recording layer, and a method in which a layer having magnetization in a direction opposite to that of magnetization of a recording layer is provided. As one of the latter method, a technique is disclosed in a literature of E. N. Abarra et al. (E. N. Abarra et al., TECHNICAL REPORT OF IEICE. MR2000-34 (2000-10)) as shown in FIG. 18, in which the thermal stability is improved by forming an Ru thin film as a magnetic coupling layer between a recording layer of CoCrPtB and a magnetization-stabilizing layer of CoCrPtB of a magnetic disk. In the structure of the magnetic disk shown in FIG. 18, when the Ru layer having a thickness of about 0.5 to 1 nm is allowed to intervene as the magnetic coupling layer between the recording layer and the magnetization-stabilizing layer, the exchange coupling is effected in an antiferromagnetic manner between the recording layer and the magnetization-stabilizing layer. Therefore, the layers have antiparallel magnetization, and hence the magnetization of the recording layer is stabilized by the magnetization-stabilizing layer. It is described in this literature that the antiferromagnetic exchange coupling effected by the Ru layer further thermally stabilizes the magnetization of the recording layer, making it possible to improve the recording and reproduction characteristics of the magnetic disk.

However, in order to realize further advanced high density recording with a magnetic recording apparatus, it is required to provide a magnetic recording apparatus which is provided with a magnetic disk that is more excellent in thermal stability than the magnetic disk disclosed in the literature described above.

A first object of the present invention is to provide a magnetic recording medium, especially an in-plane magnetic recording medium which is excellent in thermal stability, and a magnetic recording apparatus provided with the same.

A second object of the present invention is to provide a magnetic recording apparatus which is excellent in stability (recording stability) of recorded information.

A third object of the present invention is to provide a magnetic recording medium which is suitable for high density recording, and a magnetic recording apparatus installed with the same.

A fourth object of the present invention is to provide a magnetic recording medium in which the coercive force of a recording layer is enhanced.

### SUMMARY OF THE INVENTION

According to a first aspect of the present invention, there is provided a magnetic recording medium comprising:

a recording layer which is formed of a ferromagnetic material;

a ferromagnetic atom-rich layer which is formed of a ferromagnetic material having a high ferromagnetic atom concentration as compared with the ferromagnetic material for forming the recording layer; and

a non-magnetic layer which exists between the recording layer and the ferromagnetic atom-rich layer.

As a result of repeated investigations performed by the present inventors in order to further improve the magnetic disk having the conventional type structure shown in FIG. 18, it has been found out that the exchange coupling force, which is generated between the ferromagnetic atom-rich layer and the recording layer, is remarkably raised by forming the ferromagnetic atom-rich layer formed with the material having the high ferromagnetic atom concentration as compared with the ferromagnetic material for forming the recording layer, in place of the magnetization-stabilizing layer. The exchange coupling force, which is generated between the ferromagnetic atom-rich layer and the recording layer as described above, is larger than the exchange coupling force which acts between the recording layer and the magnetization-stabilizing layer of the magnetic disk having the conventional type structure shown in FIG. 18. As described above, the strong exchange coupling force is generated between the recording layer and the ferromagnetic atom-rich layer, and hence it is possible to stabilize the magnetization of the recording layer. Therefore, the thermal stability of the recording layer is further enhanced as compared with the conventional magnetic disk shown in FIG. 18, making it possible to realize further advanced high density recording. In the present invention, the term “ferromagnetic atom” means the element which exhibits the ferromagnetic property in the form of simple substance. Specifically, the ferromagnetic atom includes cobalt (Co), nickel (Ni), and iron (Fe).

The ferromagnetic atom-rich layer is formed with the ferromagnetic material which has the high ferromagnetic atom concentration as compared with the ferromagnetic material for forming the recording layer. For example, when the recording layer is formed of a ferromagnetic material containing Co, Ni, or Fe, the ferromagnetic atom-rich layer can be formed of a ferromagnetic material containing a ferromagnetic atom such as Co, Ni, and Fe at a higher concentration as compared with the recording layer. The ferromagnetic atom-rich layer can be also formed of a metal simple substance such as Co, Ni, and Fe or CoNiFe alloy. Alternatively, the ferromagnetic atom-rich layer may be formed of an alloy containing a transition metal and Co, Ni, or Fe. In this case, the transition metal may be a noble metal such as Pt, Au, Ag, Cu, and Pd. In the present invention, when the ferromagnetic atom concentration of the ferromagnetic material for constructing the ferromagnetic atom-rich layer is higher than the ferromagnetic atom concentration of the magnetic material for constructing the recording layer, it is possible to obtain the effect to enhance the exchange coupling force generated between the ferromagnetic atom-rich layer and the recording layer. However, in order to obtain a sufficient effect in view of the results obtained in the embodiments as described later on, it is desirable that the ferromagnetic atom concentration of the ferromagnetic material for constructing the ferromagnetic atom-rich layer is higher than the ferromagnetic atom concentration of the ferromagnetic material for constructing the recording layer by not less than 19% as represented by an absolute value. Especially, it is desirable that the ferromagnetic atom concentration of the ferromagnetic atom-rich layer is 100%. Owing to the ferromagnetic atom-rich layer as described above, the exchange coupling force, which is generated between the ferromagnetic atom-rich layer and the recording layer, is larger than the exchange coupling force which is generated between the magnetization-stabilizing layer and the recording layer of the conventional magnetic disk shown in FIG. 18. Therefore, the thermal stability of the recording layer is further enhanced as compared with the conventional technique, making it possible to realize further advanced high density recording.

It is preferable that the ferromagnetic atom-rich layer as described above has a film thickness of 1 nm to 5 nm in order to obtain significant exchange coupling force exerted between the ferromagnetic atom-rich layer and the recording layer.

The magnetic recording medium of the present invention may further comprise a magnetization-stabilizing layer for stabilizing magnetization of the recording layer by effecting exchange coupling with respect to the recording layer. In this case, it is preferable that the ferromagnetic atom-rich layer is positioned between the recording layer and the magnetization-stabilizing layer. The reason therefor will be explained below.

As a result of investigations performed by the present inventors, it has been found out that the exchange coupling between the recording layer and the magnetization-stabilizing layer can be remarkably improved by intervening a several-atoms-layered Co layer at an interface between the Ru layer (non-magnetic layer) and the recording layer and/or an interface between the Ru layer (non-magnetic layer) and the magnetization-stabilizing layer of the magnetic disk having the conventional type structure shown in FIG. 18. The layer to be intervened at the interface is not limited to Co, which may be composed of a material having a high ferromagnetic atom concentration as compared with the recording layer, and which may be constructed with a variety of substances capable of improving the exchange coupling between the recording layer and the magnetization-stabilizing layer as described later on. That is, when the magnetic recording medium is provided with the magnetization-stabilizing layer, the exchange coupling force between the recording layer and the magnetization-stabilizing layer can be improved by positioning the ferromagnetic atom-rich layer at the interface. In this specification, the ferromagnetic atom-rich layer is also referred to as “enhancing layer”, because the ferromagnetic atom-rich layer is also provided with the function to enhance the exchange coupling between the recording layer and the magnetization-stabilizing layer when the magnetization-stabilizing layer is provided.

According to the knowledge of the present inventors, the reason why the ferromagnetic atom-rich layer, i.e., the enhancing layer, which is positioned between the magnetization-stabilizing layer and the recording layer, successfully improves the exchange coupling between the recording layer and the magnetization-stabilizing layer is as follows. In the case of the conventional type magnetic disk shown in FIG. 18, the recording layer of CoCrPtB and the magnetization-stabilizing layer of CoCrPtB are stacked with the Ru layer intervening therebetween. In this case, the recording layer and the magnetization-stabilizing layer effect the exchange coupling via the Ru atom layer. It is considered that the exchange coupling is effected on the basis of the fact that the electron orbits are coupled between the Co atoms in the recording layer and the magnetization-stabilizing layer via the Ru atoms. Such a coupling is also found, for example, in the coupling in an artificial lattice of a GMR head.

However, when the interface between the recording layer and the Ru layer is observed, then the crystal grains in the recording layer are rich in Co, and the grain boundary therebetween has a Cr-rich composition, because the recording layer is composed of CoCrPtB. As a result, it is considered that the Cr atoms, which amount is larger than that of the Co atoms, are exposed on the surface of the recording layer on the side of the Ru layer. The magnetization-stabilizing layer is also composed of the CoCr alloy (CoCrPtB) in the same manner as the recording layer. Therefore, it is considered that a large amount of Cr atoms for covering Co are exposed on the surface of the magnetization-stabilizing layer on the side of the Ru layer. It is assumed that the Cr atom layers inhibit the electron coupling between the Co atoms in the recording layer and the magnetization-stabilizing layer via the Ru atoms as described above, thereby weakening the exchange coupling between the recording layer and the magnetization-stabilizing layer. In the present invention, the recording layer or the magnetization-stabilizing layer, on which the Cr atoms are exposed on the surface, is covered with the enhancing layer having the high concentration of the magnetic atoms such as Co as compared with the recording layer. Accordingly, it is considered that the exchange coupling between the recording layer and the magnetization-stabilizing layer is improved by the exchange coupling between the atoms such as Co for constructing the enhancing layer. Therefore, when the magnetization-stabilizing layer is provided, the magnetization of the recording layer, which is stabilized by the magnetization-stabilizing layer, is further stabilized owing to the increase of the exchange coupling force between the magnetization-stabilizing layer and the recording layer brought about by the enhancing layer, by positioning the enhancing layer between the magnetization-stabilizing layer and the recording layer. Accordingly, it is possible to realize further advanced high density recording as compared with the conventional technique.

The enhancing layer may be formed of Co, Ni, Fe, or a CoNiFe alloy. Alternatively, the enhancing layer may be formed of an alloy containing a transition metal and Co, Ni, or Fe. In this case, the transition metal may be a noble metal such as Pt, Au, Ag, Cu, and Pd. The atom or the alloy as described above functions to make the coupling electronically via the non-magnetic layer so that the exchange coupling magnetic field is increased. Alternatively, when the recording layer or the magnetization-stabilizing layer is formed of a material containing Co, Ni, or Fe, it is also effective to form the enhancing layer with a material containing Co, Ni, or Fe at a concentration higher than that of the recording layer or the magnetization-stabilizing layer.

In the present invention, an arbitrary ferromagnetic material and an arbitrary film thickness can be selected for the magnetization-stabilizing layer provided that the magnetization of the recording layer is stabilized. Further, in view of the crystal growth performance of the recording layer, it is preferable that the magnetization-stabilizing layer is formed of, for example, the same major component as the major component for constructing the recording layer. It is desirable that the magnetization-stabilizing layer has a certain degree of film thickness, because it is necessary to possess the magnetization and the magnetic anisotropy capable of stabilizing the magnetization of the recording layer. However, if the film thickness of the magnetization-stabilizing layer is excessively thick, it is feared that the coercive force of the magnetization-stabilizing layer is increased, and the magnetization of the recording layer is not antiparallel to the magnetization of the magnetization-stabilizing layer. Further, the following restriction also exists. That is, the magnetization of the magnetization-stabilizing layer must be smaller than the magnetization of the recording layer, in order to generate the leak magnetic field which is effective on the side on which the magnetic head is positioned with respect to the medium. For the reason as described above, it is preferable that the film thickness of the magnetization-stabilizing layer is within a range of ⅕ to ⅗ of the film thickness of the recording layer.

The magnetic recording medium according to the present invention may further comprise a second enhancing layer between the recording layer and the non-magnetic layer. In the present invention, it is desirable that the second enhancing layer is formed between the recording layer and the non-magnetic layer, when the magnetization-stabilizing layer is provided and the ferromagnetic atom-rich layer is positioned between the magnetization-stabilizing layer and the recording layer, in order to further enhance the exchange coupling between the recording layer and the magnetization-stabilizing layer. It is desirable that the second enhancing layer as described above has a film thickness of 0.2 to 2.0 nm, in order to obtain a significant enhancing effect of the exchange coupling which is exerted between the recording layer and the ferromagnetic atom-rich layer.

When the magnetization-stabilizing layer is provided as described above, and the ferromagnetic atomrich layer is positioned between the magnetization-stabilizing layer and the recording layer, then the magnetization-stabilizing layer may be composed of a first magnetization-stabilizing layer and a second magnetization-stabilizing layer, and a second non-magnetic layer may be provided between the first magnetization-stabilizing layer and the second magnetization-stabilizing layer. In this arrangement, an auxiliary enhancing layer, which increases exchange coupling between the first magnetization-stabilizing layer and the second magnetization-stabilizing layer, may be provided at least at one of positions between the first magnetization-stabilizing layer and the second non-magnetic layer and between the second non-magnetic layer and the second magnetization-stabilizing layer. Further, the auxiliary enhancing layer may include a first auxiliary enhancing layer which is formed between the first non-magnetic layer and the first magnetization-stabilizing layer, and a second auxiliary enhancing layer which is formed between the first non-magnetic layer and the second magnetization-stabilizing layer. The auxiliary enhancing layer may be composed of the same material as that of the enhancing layer described above.

It is desirable that the enhancing layer (as well as the auxiliary enhancing layer) has a film thickness of 0.2 to 3 nm, preferably 0.2 to 2 nm, in order to obtain a significant enhancing effect for the exchange coupling.

In the magnetic recording medium according to the first aspect of the present invention, the recording layer may be crystalline, and the crystalline phase may be composed of an alloy principally containing cobalt (Co). The Co alloy may contain Co as well as Cr, Pt, Ta, Nb, Ti, Si, B, P, Pd, V, Tb, Gd, Sm, Nd, Dy, Ho, Eu, or a combination thereof.

When the recording layer contains chromium (Cr), it is possible to form a segregation portion of Cr at the grain boundary or in the vicinity of the grain boundary between the crystal grains (magnetic grains) principally containing Co. When the recording layer further contains Ta, Nb, Ti, B, P, or a combination of these elements, the segregation of Cr is facilitated. Owing to the segregation, it is possible to reduce the magnetic interaction between the magnetic grains, and it is possible to decrease the number of magnetic grains for constructing the unit of inversion of magnetization. If the segregation of Cr is facilitated by including the foregoing additive in the recording layer as described above, it has been feared for the conventional magnetic recording medium to cause the following situation. That is, the magnetic interaction between the recording layer and the magnetization-stabilizing layer is also reduced, and the thermal stability of the recording layer is lowered. However, in the case of the magnetic recording medium according to the present invention, even when the magnetic interaction between the magnetic grains in the recording layer is reduced by including the foregoing additive in the recording layer, the increased coupling force is exerted between the recording layer and the ferromagnetic atom-rich layer. Therefore, it is possible to provide the magnetic recording medium which is strong against the thermal fluctuation regardless of the minute unit of inversion of magnetization. In the present invention, it is preferable that the recording layer contains a material for further facilitating the segregation of Cr of the foregoing additives, for example, Boron (B).

The magnetic recording medium according to the first aspect of the present invention may further comprise a substrate, and an underlying base layer which is formed on the substrate. In this arrangement, the magnetic recording medium may comprise the ferromagnetic atom-rich layer on the underlying base layer. The substrate may be formed of glass or plastic such as polycarbonate. The underlying base layer may be formed of Cr, Ni, Cr alloy, or Ni alloy. The Cr alloy or the Ni alloy may contain Cr, Ti, Ta, V, Ru, W, Mo, Nb, Ni, Zr, or Al other than the base element. The underlying base layer is used in order to control the crystalline orientation and the lattice constant of the magnetic layer. The underlying base layer may be also used as a single layer or a plurality of layers.

The magnetic recording medium according to the present invention may further comprise a substrate, a second non-magnetic layer, and a magnetization-stabilizing layer which is positioned therebetween and which thermally stabilizes magnetization of the recording layer. In this arrangement, the ferromagnetic atom-rich layer is positioned on a side opposite to the side on which the substrate exists with respect to the second non-magnetic layer. The second non-magnetic layer may be composed of the same material as that of the non-magnetic layer described above. The magnetization-stabilizing layer may be composed of, for example, the same material as that of the recording layer. In the magnetic recording medium as described above, it is possible to further stabilize the magnetization of the recording layer owing to the magnetization-stabilizing layer.

The magnetic recording medium according to the first aspect of the present invention may further comprise a substrate, a second non-magnetic layer, and a second ferromagnetic atom-rich layer which is positioned therebetween. In this arrangement, the ferromagnetic atom-rich layer is positioned on a side opposite to the side on which the substrate exists with respect to the second non-magnetic layer. The second ferromagnetic atom-rich layer may be formed by using the same material as that of the ferromagnetic atom-rich layer described above. The magnetic recording medium having the structure as described above is extremely excellent in thermal stability, because the exchange coupling magnetic field is further increased by the aid of the second ferromagnetic atom-rich layer.

According to a second aspect of the present invention, there is provided a magnetic recording medium comprising:

an underlying base layer;

a recording layer which is formed of a ferromagnetic material;

a lattice spacing-adjusting layer which exists between the underlying base layer and the recording layer while making contact with the underlying base layer, which is formed of a ferromagnetic material, and which is provided to adjust lattice spacing for the underlying base layer and the recording layer; and

a non-magnetic layer which exists between the recording layer and the lattice spacing-adjusting layer, wherein:

a difference between lattice spacing on an orientation plane of the lattice spacing-adjusting layer and lattice spacing on an orientation plane of the underlying base layer is smaller than a difference between lattice spacing on an orientation plane of the recording layer and the lattice spacing on the orientation plane of the underlying base layer.

The magnetic recording medium of the present invention comprises the lattice spacing-adjusting layer which is formed between the underlying base layer and the recording layer and which is formed of the ferromagnetic material to make control so that the difference in lattice spacing between the lattice spacing-adjusting layer and the underlying base layer is smaller than the difference in lattice spacing between the recording layer and the underlying base layer. The lattice spacing-adjusting layer as described above mitigates the lattice strain between the underlying base layer and the recording layer, and the crystalline orientation of the recording layer is improved thereby. Accordingly, it is possible to increase the coercive force of the recording layer. The magnetic recording medium as described above is formed of the ferromagnetic material in the same manner as the magnetization-stabilizing layer of the in-plane magnetic recording medium having the conventional type structure shown in FIG. 18. Therefore, it is possible to stabilize the magnetization of the recording layer. That is, the lattice spacing-adjusting layer has a function to stabilize the magnetization of the recording layer, in addition to a function as a seed layer to act so that the lattice strain between the underlying base layer and the recording layer, i.e., the discrepancy of lattice spacing is mitigated. Therefore, the high density recording can be put into practice by using the magnetic recording medium of the present invention, because the minute magnetic domain formed in the recording layer can be stably retained. In the present invention, the term “lattice spacing” means the lattice spacing on the orientation plane.

In the magnetic recording medium according to the second aspect of the present invention, the coercive force of the recording layer can be increased owing to the lattice spacing-adjusting layer as compared with a case in which the recording layer is formed as a single layer. Accordingly, information can be recorded at a high density on the recording layer. Further, the thermal stability of recorded information is excellent. Further, the exchange coupling force is exerted with respect to the recording layer via the non-magnetic layer, because the lattice spacing-adjusting layer is formed of the ferromagnetic material. Therefore, the lattice spacing-adjusting layer also functions to stabilize the magnetization of the recording layer. In order to increase the coercive force of the recording layer, the mismatch in lattice spacing between the lattice spacing-adjusting layer and the recording layer may be reduced. In order to reduce the mismatch in lattice spacing between the lattice spacing-adjusting layer and the recording layer, for example, the underlying base layer may be improved as follows. That is, the underlying base layer, which has a structure similar to the crystal structure of the recording layer, may be used so that the orientation of the recording layer is controlled and a high coercive force is obtained. In order to increase the coercive force of the recording layer, the crystal grain diameter of the lattice spacing-adjusting layer may be controlled.

In the magnetic recording medium according to the second aspect of the present invention, it is preferable that the relationship of Δ1>Δ2 is satisfied provided that the lattice spacing on the orientation plane of the recording layer is defined as a₁, the lattice spacing of the lattice spacing-adjusting layer is defined as a₂, the lattice spacing of the underlying base layer is defined as a₃, and the mismatch Δ1 in lattice spacing between the recording layer and the underlying base layer and the mismatch Δ2 in lattice spacing between the lattice spacing-adjusting layer and the underlying base layer are defined by the following expression:

Δi=|(aᵢ−a₃)/a₃|×100(i is 1 or 2) (1)

provided that the symbol “||” indicates the absolute value in the expression (1). In general, the mismatch in lattice spacing results from the difference in lattice spacing at the interface between the respective layers of the stack obtained by growing and stacking a plurality of layers. The recording layer is grown from the top of the lattice spacing-adjusting layer via the non-magnetic layer. Therefore, the orientation of the recording layer depends on the difference in lattice spacing between the recording layer and the lattice spacing-adjusting layer. On the other hand, the orientation of the lattice spacing-adjusting layer depends on the difference in lattice spacing between the lattice spacing-adjusting layer and the underlying base layer. As described above, the mismatch Δ2 in lattice spacing between the lattice spacing-adjusting layer and the underlying base layer is made smaller than the mismatch Δ1 in lattice spacing between the recording layer and the underlying base layer. Accordingly, it is possible to allow the lattice spacing-adjusting layer to function as a seed layer for the recording layer, and it is possible to grow the recording layer from the underlying base layer in a desired orientation.

In order to further enhance the lattice match between the underlying base layer and the recording layer, it is desirable to reduce the mismatch in lattice spacing between the lattice spacing-adjusting layer and the recording layer and the mismatch in lattice spacing between the recording layer and the underlying base layer to be within 5% respectively. For this purpose, it is preferable that the mismatches Δ1, Δ2 simultaneously satisfy the relationships of Δ2<Δ1<10.25 and (5/10.25)<(Δ2/Δ1)<1. When the value of (Δ2/Δ1) is within the range as described above, if any lattice strain exists between the underlying base layer and the recording layer, then the lattice strain can be effectively mitigated by the lattice spacing-adjusting layer. Thus, the recording layer having the desired lattice spacing can be formed from the top of the underlying base layer via the lattice spacing-adjusting layer. Accordingly, it is possible to further increase the coercive force of the recording layer.

In the present invention, it is ideal that the lattice spacing-adjusting layer has the same crystal structure as that of the recording layer, because it is necessary to control and orient the magnetization-prompt axis of the recording layer in the in-plane direction. In the case of the magnetic recording medium based on the in-plane recording system, when the exchange coupling is effected between the lattice spacing-adjusting layer and the recording layer, the magnetic anisotropy energy is lowest if the magnetization of the lattice spacing-adjusting layer is parallel to the magnetization of the recording layer, and the stability of the magnetization is in the best state.

It is desirable for the magnetic recording medium according to the second aspect of the present invention that a relationship of Ms1>Ms2 is satisfied provided that saturation magnetization of the lattice spacing-adjusting layer is represented by Ms1, and saturation magnetization of the recording layer is represented by Ms2. For this purpose, it is desirable that the lattice spacing-adjusting layer is formed so that a ratio of magnetic atom contained in the lattice spacing-adjusting layer is larger than a ratio of magnetic atom contained in the recording layer. Accordingly, it is possible to further increase the exchange coupling force between the recording layer and the lattice spacing-adjusting layer. In the case of the conventional type medium shown in FIG. 18, the recording layer and the magnetization-stabilizing layer are composed of the same material, in which the composition and the crystal structure are also the same. The recording layer and the magnetization-stabilizing layer are subjected to exchange coupling via the Ru layer. It is considered that the exchange coupling is based on the fact that the electron orbits are coupled to one another for the Co atoms in the recording layer and the magnetization-stabilizing layer by the aid of the Ru atoms. In the present invention, the ratio of the magnetic element in the lattice spacing-adjusting layer is made higher than the ratio of the magnetic element in the recording layer to increase the amount of magnetic element which contributes to the exchange coupling. Therefore, the exchange coupling force between the recording layer and the lattice spacing-adjusting layer is increased as compared with the exchange coupling force between the recording layer and the magnetization-stabilizing layer of the conventional type medium shown in FIG. 18. Accordingly, it is possible to improve the thermal stability as compared with the conventional type medium shown in FIG. 18.

The lattice spacing-adjusting layer may be formed of, for example, an alloy containing Co, Ni, or Fe. Alternatively, the lattice spacing-adjusting layer may be formed of an alloy containing Co, Ni, or Fe and a transition metal, especially a noble metal such as Pt, Au, Ag, Cu, and Pd. The element or the alloy as described above functions to electronically make coupling by the aid of the non-magnetic layer and increase the exchange coupling magnetic field.

In the present invention, the coercive force of the recording layer and the exchange coupling force between the recording layer and the lattice spacing-adjusting layer can be controlled by adjusting the film thickness and the material to be used for the lattice spacing-adjusting layer. As shown in FIG. 15, the following tendency exists. That is, when the film thickness of the lattice spacing-adjusting layer is thick, the coercive force of the recording layer is increased. When the film thickness is thin, the exchange coupling force between the recording layer and the lattice spacing-adjusting layer is increased. Therefore, it is possible to appropriately select the film thickness depending on which characteristic has priority. According to experimental results having been obtained until now, it has been revealed that the exchange coupling between the lattice spacing-adjusting layer and the recording layer does not exhibit anti-ferromagnetic exchange coupling in some cases, if the film thickness of the lattice spacing-adjusting layer exceeds 9.0 nm. On the other hand, it has been revealed that the lattice match between the lattice spacing-adjusting layer and the recording layer formed thereon is maintained, and it is possible to sufficiently increase the coercive force of the recording layer, if the film thickness of the lattice spacing-adjusting layer is not less than 1.0 nm. Accordingly, in order to increase both of the coercive force of the recording layer and the exchange coupling force between the recording layer and the lattice spacing-adjusting layer in a well-balanced manner, it is preferable that the film thickness of the lattice spacing-adjusting layer is 1.0 nm to 9.0 nm.

In the magnetic recording medium according to the second aspect of the present invention, the recording layer may be crystalline, and the crystalline phase may be composed of an alloy principally containing cobalt (Co). The Co alloy may contain Co as well as Cr, Pt, Ta, Nb, Ti, Si, B, P, Pd, V, Tb, Gd, Sm, Nd, Dy, Ho, Eu, or a combination thereof.

When the recording layer contains chromium (Cr), it is possible to form a segregation portion of Cr at the grain boundary or in the vicinity of the grain boundary between the crystal grains (magnetic grains) principally containing Co. When the recording layer further contains Ta, Nb, Ti, B, P, or a combination of these elements, the segregation of Cr is facilitated. Owing to the segregation, it is possible to reduce the magnetic interaction between the magnetic grains, and it is possible to decrease the number of magnetic grains for constructing the unit of inversion of magnetization. Therefore, it is possible to provide the magnetic recording medium which is strong against the thermal fluctuation regardless of the minute unit of inversion of magnetization, when the lattice spacing-adjusting layer of the present invention is used in combination with the recording layer containing the foregoing additive in the CoCr alloy. In the recording layer as described above, the magnetic coupling between the crystal grains is broken by the Cr-rich non-magnetic area segregated at the grain boundary. Therefore, the noise, which would otherwise result from the recording transition area, can be also suppressed.

In the magnetic recording medium according to the second aspect of the present invention, the underlying base layer may be formed of, for example, Cr, Ni, Cr alloy, or Ni alloy. The Cr alloy or the Ni alloy may contain Cr, Ti, Ta, V, Ru, W, Mo, Nb, Ni, Zr, or Al other than the base element. The underlying base layer is used in order to control the crystalline orientation and the lattice spacing of the recording layer. The underlying base layer may be also used as a single layer or a plurality of layers.

The magnetic recording medium according to the second aspect of the present invention may further comprise a substrate. In this arrangement, the underlying base layer is formed on the substrate. The substrate may be formed of glass or plastic such as polycarbonate.

In the magnetic recording media according to the first and second aspects of the present invention, the non-magnetic layer (and the second non-magnetic layer) may be formed of Ru. However, there is no limitation thereto. It is possible to use a transition metal such as Rh, Ir, Hf, Cu, Cr, Ag, Au, Re, Mo, Nb, W, Ta, and V, and a non-magnetic alloy based on the CoCr system such as CoCrRu. Ru is preferred in order to further enhance the exchange coupling between the ferromagnetic atom-rich layer and the recording layer, the exchange coupling between the recording layer and the lattice spacing-adjusting layer, or the exchange coupling between the recording layer and the magnetization-stabilizing layer. In the present invention, the non-magnetic layer has a function to magnetically couple the recording layer and the ferromagnetic atom-rich layer, the recording layer and the lattice spacing-adjusting layer, or the recording layer and the magnetization-stabilizing layer. Therefore, the non-magnetic layer is also referred to as “magnetic coupling layer”.

Each of the magnetic recording media according to the first and second aspects of the present invention has a magnetic characteristic which is represented by a hysteresis loop as depicted by a magnetization curve as shown in FIGS. 4 and 16. The following description will be made on the basis of a case of the magnetic recording medium according to the first aspect. However, an equivalent relationship is also affirmed between the lattice spacing-adjusting layer and the recording layer of the magnetic recording medium according to the second aspect. In the hysteresis loop shown in FIG. 4, a point, at which a rate of change of magnetization with respect to the external magnetic field exhibits a local maximum when the external magnetic field is lowered after magnetization of the magnetic recording medium is saturated, exists in an area of positive magnetic field. When the magnetization of the magnetic recording medium is saturated, both of the magnetizations of the recording layer and the ferromagnetic atom-rich layer (or the lattice spacing-adjusting layer) are parallel. The magnetization of the ferromagnetic atom-rich layer (or the lattice spacing-adjusting layer) is inverted due to the exchange coupling force exerted between the ferromagnetic atom-rich layer (or the lattice spacing-adjusting layer) and the recording layer in the area in which the rate of change of magnetization exhibits the local maximum as the external magnetic field is lowered. In the residual magnetization state, the thermal stability of the magnetization of the recording layer is improved owing to the exchange coupling force as described above. Further, a minor hysteresis loop as shown in FIG. 4 may be observed in the area in which the rate of change of magnetization is locally maximized. The minor hysteresis loop is shown in FIG. 5A. The exchange coupling magnetic field Hₑₓ, which is determined from the central point of the minor hysteresis loop, is increased in accordance with the increase of the exchange coupling force between the ferromagnetic atom-rich layer (or the lattice spacing-adjusting layer) and the recording layer. Therefore, it is indicated that the larger the exchange coupling magnetic field is, the larger the thermal stability is. The exchange coupling magnetic field Hₑₓ is not less than 1 kOe, preferably not less than 1.5 kOe, which is remarkably larger than that of the conventional type magnetic recording medium shown in FIG. 18. Therefore, it is appreciated that the magnetic recording medium of the present invention is excellent in thermal stability.

In order to generate the large exchange coupling magnetic field Hₑₓ in the magnetic recording medium according to the second aspect of the present invention as described above, for example, it is desirable that the lattice spacing-adjusting layer is formed so that the ratio of the magnetic element contained in the lattice spacing-adjusting layer is larger than the ratio of the magnetic element contained in the recording layer.

According to a third aspect of the present invention, there is provided a magnetic recording medium comprising:

a recording layer which is formed of a ferromagnetic material;

a magnetization-stabilizing layer which is formed of a ferromagnetic material and which stabilizes magnetization of the recording layer;

a non-magnetic layer which exists between the recording layer and the magnetization-stabilizing layer; and

a ferromagnetic atom-rich layer which exists at least at one of positions between the non-magnetic layer and the recording layer and between the non-magnetic layer and the magnetization-stabilizing layer and which is formed of a ferromagnetic material having a ferromagnetic atom concentration higher than that of the ferromagnetic material for forming the recording layer.

In the magnetic recording medium according to the third aspect of the present invention, the ferromagnetic atom-rich layer, in which the ferromagnetic atom concentration is higher than that of the recording layer, may be formed to cover the surface of the recording layer disposed on the side of the non-magnetic layer or the surface of the magnetization-stabilizing layer on the side of the non-magnetic layer. Accordingly, in the same manner as in the case of the magnetic recording medium according to the first aspect described above, the exchange coupling between the recording layer and the magnetization-stabilizing layer is improved and increased by the exchange coupling between the magnetic atoms which constructs the ferromagnetic atom-rich layer and the recording layer, respectively or by the exchange coupling between the magnetic atoms which constructs the ferromagnetic atom-rich layer and the magnetization-stabilizing layer, respectively. Therefore, the magnetization of the recording layer, which has been stabilized by the magnetization-stabilizing layer, is further stabilized in accordance with the increase of the exchange coupling force between the magnetization-stabilizing layer and the recording layer brought about by the ferromagnetic atom-rich layer. Therefore, it is possible to realize further advanced high density recording as compared with the conventional technique. The ferromagnetic atom-rich layer of the magnetic recording medium according to the third aspect also increase (enhances) the exchange coupling force between the magnetization-stabilizing layer and the recording layer, in the same manner as in the case of the magnetic recording medium according to the first aspect. Therefore, the ferromagnetic atom-rich layer of the magnetic recording medium according to the third aspect is also referred to as “enhancing layer”. The ferromagnetic atom-rich layer may be constructed by using the same materials as those for the magnetic recording medium according to the first aspect of the present invention.

According to a fourth aspect of the present invention, there is provided a magnetic recording apparatus comprising:

the magnetic recording medium according the first, second, or third aspect of the present invention;

a magnetic head which is used to record or reproduce information on the magnetic recording medium; and

a driving unit which drives the magnetic recording medium with respect to the magnetic head. The magnetic recording apparatus according to the present invention is excellent in recording stability over a long period of time, because the magnetic recording apparatus is installed with the magnetic recording medium which is excellent in thermal stability.

### BRIEF DESCRIPTION OF THE DRAWINGS

FIG. 1 shows a cross-sectional structure of a magnetic disk according to a first embodiment.

FIG. 2 shows a cross-sectional structure of a modified embodiment of the magnetic disk according to the first embodiment.

FIG. 3 shows a cross-sectional structure of another modified embodiment of the magnetic disk according to the first embodiment.

FIG. 4 shows a graph illustrating a hysteresis loop (major loop) of the magnetic disk according to the first embodiment.

FIG. 5A shows a minor loop of the hysteresis loop shown in FIG. 4, and

FIG. 5B shows a minor loop of a hysteresis loop of a magnetic disk concerning Comparative Example 1.

FIG. 6 shows a schematic cross-sectional structure of a magnetic disk according to a fourth embodiment of the present invention.

FIG. 7 shows a cross-sectional structure of the magnetic disk concerning Comparative Example 1.

FIG. 8 shows a schematic arrangement of an exemplary magnetic recording apparatus according to a second embodiment of the present invention as viewed from a position thereover.

FIG. 9 shows a sectional view as viewed in a direction of A-A′ illustrating the magnetic recording apparatus shown in FIG. 8.

FIG. 10 shows a schematic sectional view illustrating a magnetic disk produced in a third embodiment of the present invention.

FIG. 11 shows graphs illustrating a hysteresis loop (major loop) of the magnetic disk shown in FIG. 10, and a magnified view of a minor loop of the hysteresis loop.

FIG. 12 shows a schematic sectional view illustrating a modified embodiment of the magnetic disk according to the third embodiment of the present invention.

FIG. 13 shows a schematic sectional view illustrating another modified embodiment of the magnetic disk according to the third embodiment of the present invention.

FIG. 14 shows a graph illustrating a hysteresis loop (major loop) of a magnetic disk according to a fourth embodiment.

FIG. 15 shows a graph illustrating a relationship between a film thickness of a lattice spacing-adjusting layer and a coercive force of a recording layer and a relationship between the film thickness of the lattice spacing-adjusting layer and an exchange coupling magnetic field concerning the magnetic disk according to the fourth embodiment.

FIG. 16 schematically shows a minor loop of the hysteresis loop shown in FIG. 2.

FIG. 17A shows a graph illustrating the change of exchange coupling energy with respect to the ferromagnetic atom (Co) concentration of a ferromagnetic atom-rich layer, and

FIG. 17B shows a graph illustrating the change of (Ku·V)/k_{B}·T with respect to the ferromagnetic atom (Co) concentration of the ferromagnetic atom-rich layer.

FIG. 18 shows a sectional view illustrating a structure of a conventional magnetic disk.

### DESCRIPTION OF THE PREFERRED EMBODIMENTS

The magnetic recording medium and the magnetic recording apparatus according to the present invention will be specifically explained below in accordance with embodiments and Comparative Examples. However, the present invention is not limited to the embodiments.

### FIRST EMBODIMENT

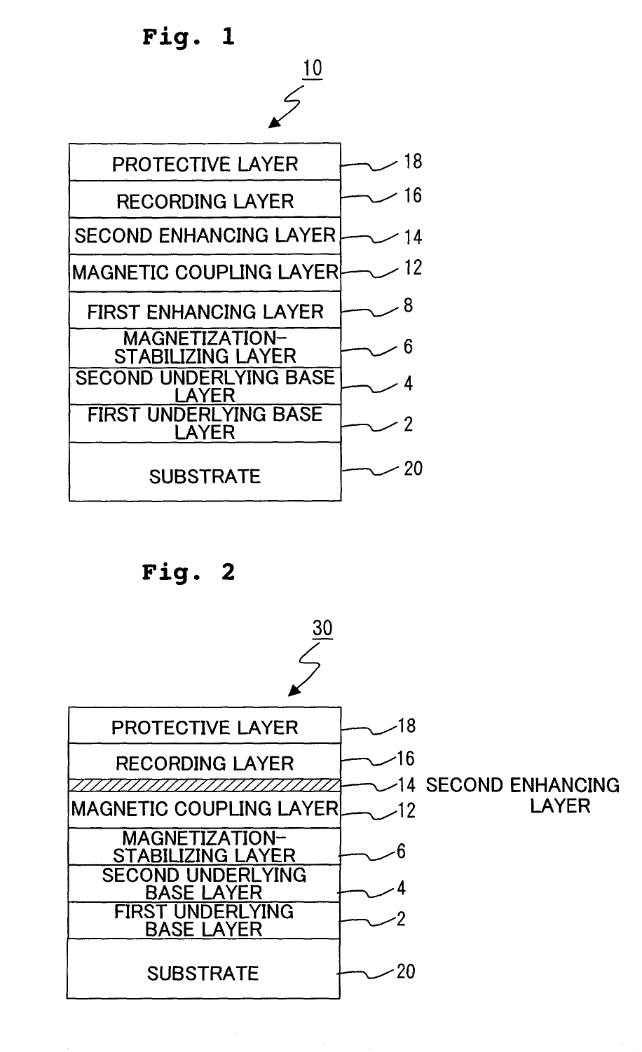

FIG. 1 shows a sectional view of a preferred embodiment of the magnetic recording medium according to the magnetic recording medium. A magnetic recording medium 10 comprises, on a glass substrate 20, a first underlying base layer 2, a second underlying base layer 4, a magnetization-stabilizing layer 6, a first enhancing layer (ferromagnetic atom-rich layer) 8, a magnetic coupling layer (non-magnetic layer) 12, a second enhancing layer 8, a recording layer 16, and a protective layer 18. The respective layers were formed as follows by means of sputtering by using a DC magnetron sputtering apparatus.

An NiAl film was formed as the first metal underlying base layer 2 on the glass substrate 20 having a diameter of 2.5 inches (6.25 cm) by means of sputtering by using the DC magnetron sputtering apparatus. An NiAl alloy having an atomic ratio of Ni:Al=50:50 was used for a target. The NiAl film had a film thickness of 50 nm. The Ar gas pressure during the sputtering was 0.3 Pa, and the introduced electric power was 0.5 kW. The substrate was heated to 340° C. after the pressure of the sputtering chamber was reduced to be not more than 1×10⁻⁵ Pa before starting the sputtering. The speed of film formation was about 3 nm/second under this condition.

A CrMo film was formed as the second metal underlying base layer 4 to have a film thickness of 20 nm on the first metal underlying base layer 2. A CrMo alloy containing Mo by 27 atomic % was used for a target. The film formation condition was the same as that for the first metal underlying base layer 2.

A CoCrPtB film was formed as the magnetization-stabilizing layer 6 to have a film thickness of 6 nm on the first metal underlying base layer 4. A Co₆₄Cr₂₀Pt₁₂B₄ alloy was used for a target. The film formation condition was the same as that for the first metal underlying base layer 2.

Subsequently, a Co film was formed as the first enhancing layer 8 to have a film thickness of 1 nm on the magnetization-stabilizing layer 6. Co was used for a target. The film formation during the sputtering was the same as that for the first metal underlying base layer 2 except that the introduced electric power was 100 W, and the spacing distance between the substrate and the target was lengthened.

Subsequently, an Ru film was formed as the magnetic coupling layer 12 to have a film thickness of 0.8 nm on the first enhancing layer 8. Ru was used for a target. The film formation condition during the sputtering was the same as that for the first enhancing layer 8.

A Co film was formed as the second enhancing layer 14 in the same manner as the first enhancing layer 8. The first enhancing layer 8 and the second enhancing layer 14 function to increase the exchange coupling between the recording layer 16 and the magnetization-stabilizing layer 6.

A CoCrPtB film having magnetization in the in-plane direction was formed as the recording layer 16 to have a film thickness of 18 nm on the second enhancing layer 14. A Co₆₄Cr₂₀Pt₁₂B₄ alloy was used for a target. The film formation condition was the same as that for the magnetization-stabilizing layer 6.

Finally, a carbon layer was formed as a protective film to have a film thickness of 5 nm on the CoCrPtB recording layer 16. The film formation condition was the same as that for the first metal underlying base layer 2. Thus, the magnetic disk 10 having the structure shown in FIG. 1 was produced.

### COMPARATIVE EXAMPLE 1

A magnetic disk was produced as Comparative Example in the same manner as in the first embodiment except that the first and second enhancing layers were not formed. FIG. 7 shows a structure of the magnetic disk 50 of Comparative Example obtained as described above.

### EVALUATION OF MAGNETIZATION CURVE

The magnetic characteristics of the magnetic disk produced in the first embodiment were measured as follows. The magnetic field was applied with VSM (Vibration Sample Magnetometer) to observe the magnetization curve with respect to the external magnetic field. An obtained result is shown in FIG. 4. As appreciated from a hysteresis loop shown in FIG. 4, an area exists, in which the magnetization is suddenly lowered before the external magnetic field is zero when the external magnetic field is lowered after the external magnetic field in the positive direction is applied to saturate the magnetization. In this area, a point appears, at which the rate of change of magnetization with respect to the external magnetic field (δM/δH) is locally maximized. In this area, the magnetization curve depicts a minor loop which exhibits hysteresis. The reason why the minor loop appears is considered as follows. That is, the direction of magnetization of the recording layer 16 is parallel to that of the magnetization-stabilizing layer 6 before arrival at the local maximum point of the rate of change. However, the direction of magnetization of the magnetization-stabilizing layer 6 is inverted at the local maximum point.

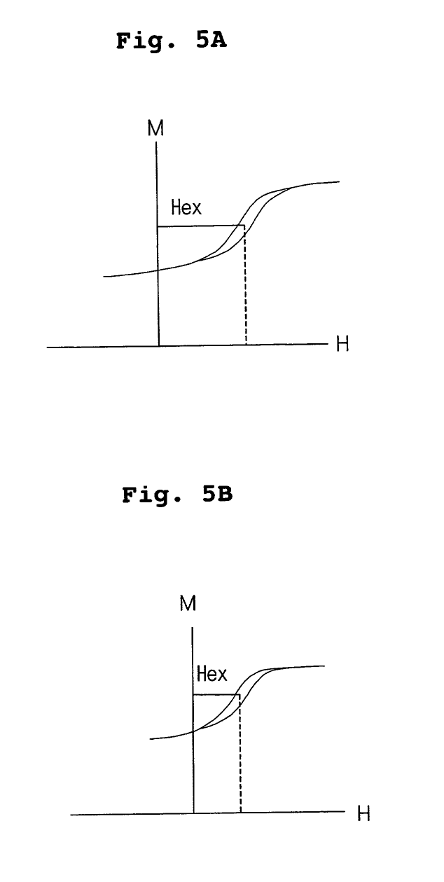

FIG. 5A shows a magnified view of the minor loop. The minor loop resides in the magnetization curve which has been obtained such that the external magnetic field in the positive direction is applied to saturate the magnetizations of the recording layer and the magnetization-stabilizing layer, and then the magnetic field is lowered to stabilize the rate of change of magnetization, followed by increasing the external magnetic field again. It is noted that the magnetic field H, which is obtained at the center of the loop and which is located at the midpoint between the upper end and the lower end of the minor loop, is known as the exchange coupling magnetic field Hₑₓ which exhibits the exchange coupling of magnetization between the recording layer 16 and the stabilizing layer 6. It has been revealed that Hₑₓ is 1.4 kOe in the case of the magnetic disk obtained in this embodiment. On the other hand, in the case of the magnetic disk of Comparative Example, a hysteresis minor loop as shown in FIG. 5B is obtained, for which it has been revealed that Hₑₓ is 0.4 kOe. Therefore, the exchange coupling force between the recording layer and the magnetization-stabilizing layer is remarkably improved in the present invention, because the first and second enhancing layers are provided at the interface between the recording layer and the magnetic coupling layer and at the interface between the magnetic coupling layer and the magnetization-stabilizing layer respectively. For reference, it has been reported that the magnetic disk, which is disclosed in the literature described in the section of prior art, has Hₑₓ of about 450 (Oe).

Further, the volume of activation V of each of the magnetic recording media obtained in the first embodiment and Comparative Example was measured to determine the value (Ku·V)/(k·T) as an index of thermal stability of the magnetic recording medium. As a result, the value was about 71 in the case of the magnetic recording medium of the first embodiment, while the value was 65 in the case of the magnetic recording medium of Comparative Example. Also from this fact, it is understood that the magnetic recording medium of the present invention is excellent in thermal stability. Further, in the case of the magnetic recording medium of the embodiment, Brt (=4πMr·t (wherein Mr represents the residual magnetic field, and t represents the thickness)), which is an index to exhibit the possibility of high density recording of the in-plane magnetic recording medium, was about 44 Gμm.

### FIRST MODIFIED EMBODIMENT

In the magnetic disk according to the present invention, the enhancing layer, which enhances the exchange coupling between the recording layer and the magnetization-stabilizing layer, may be provided at any one of the interface between the recording layer and the magnetic coupling layer (non-magnetic layer) and the interface between the magnetic coupling layer and the magnetization-stabilizing layer. As a modified embodiment of the first embodiment, FIG. 3 shows a structure of a magnetic disk 40 in which the second enhancing layer is not formed.

### SECOND MODIFIED EMBODIMENT

In the first embodiment, each one layer of the magnetization-stabilizing layer 6 and the magnetic coupling layer 12 has been formed. However, two layers of the former and the two layer of the latter may be formed. That is, it is possible to provide a structure comprising, on a second underlying base layer 4 of CrMo, a first magnetization-stabilizing layer of CoCrPtB, a first enhancing layer, a first magnetic coupling layer of Ru, a second enhancing layer of Co, a second magnetization-stabilizing layer of CoCrPtB, a third enhancing layer, a second magnetic coupling layer of Ru, a fourth enhancing layer of Co, a recording layer of CoCrPtB, and a protective layer of carbon. In this case, the first and second enhancing layers (auxiliary enhancing layers) function to increase the exchange coupling between the first and second magnetization-stabilizing layers. The third and fourth enhancing layers function to increase the exchange coupling between the recording layer and the second magnetization-stabilizing layer. In the magnetic disk 40 shown in FIG. 3, a second magnetization-stabilizing layer, a fourth enhancing layer, and a second magnetic coupling layer may be provided between the magnetic coupling layer 12 and the recording layer 16.

### SECOND EMBODIMENT

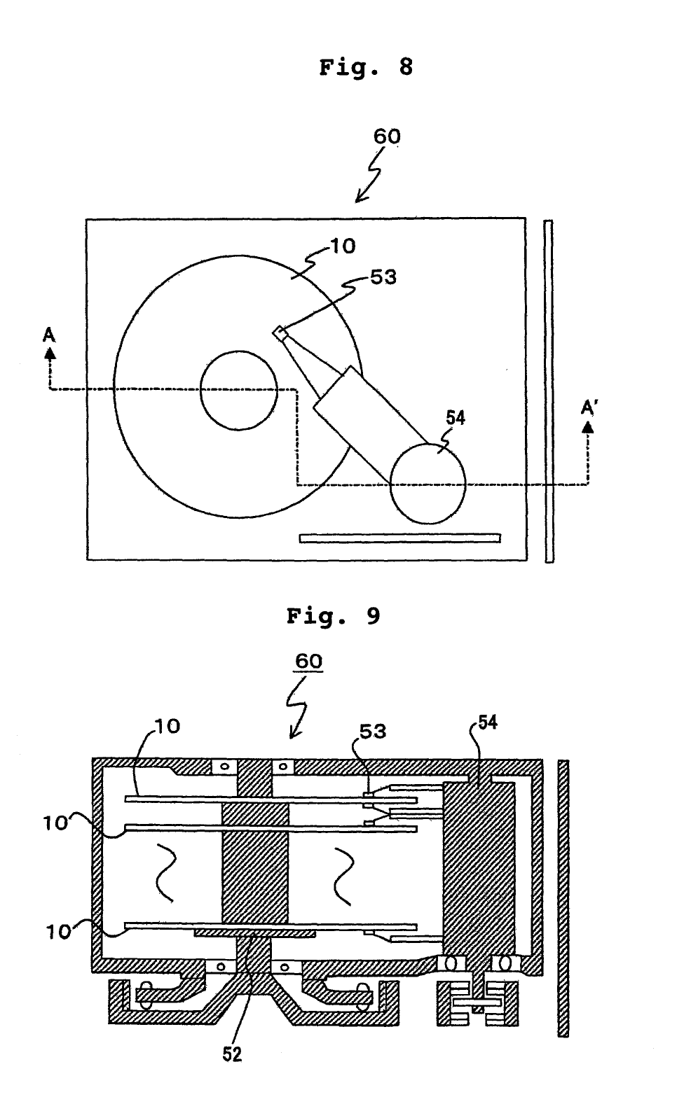

A plurality of magnetic disks were produced in accordance with the same process as that used in the first embodiment. A lubricant was applied onto the protective layers of the respective disks, and then the disks were coaxially attached to a spindle of a magnetic recording apparatus. A schematic arrangement of the magnetic recording apparatus is shown in FIGS. 8 and 9. FIG. 8 shows a top view of the magnetic recording apparatus, and FIG. 9 shows a cross-sectional view of the magnetic recording apparatus 60 taken along a broken line A-A′ shown in FIG. 8. A thin film magnetic head, which was based on the use of a soft magnetic film having a high saturation magnetic flux density of 2.1 T, was used as a recording magnetic head. A dual spin bulb-type magnetic head, which had the giant magnetic resistance effect, was used for the purpose of reproduction. The recording magnetic head and the reproducing magnetic head were integrated into one unit, and they are indicated as a magnetic head 53 in FIGS. 8 and 9. The integrated type magnetic head 53 is controlled by a magnetic head-driving system 54. The plurality of magnetic disks 10 are coaxially rotated by the spindle 52 of a rotary driving system 51. The distance between the magnetic disk and the magnetic head surface of the magnetic recording apparatus was maintained to be 11 nm. A signal corresponding to 40 Gbits/inch² (6.20 Gbits/cm²) was recorded on the magnetic disk to evaluate S/N of the magnetic disk. As a result, a reproduction output of 25 dB was obtained.

In order to evaluate the recording stability of the magnetic recording apparatus 60, the magnetic recording eapparatus 60 was placed in an environment at 80° C. at a humidity of 80% for 100 hours. After the passage of 100 hours, the recorded signal was reproduced to measure S/N of the magnetic disk. As a result, a reproduction output of 24.3 dB was obtained. That is, the rate of decrease of the recording signal in the environment described above was 3%.

### COMPARATIVE EXAMPLE 2

The magnetic disk 50 of Comparative Example 1 was incorporated into the magnetic recording apparatus in the same manner as in the second embodiment. In order to evaluate the recording stability of the magnetic recording apparatus, the magnetic recording apparatus 60 was placed in an environment at 80° C. at a humidity of 80% for 100 hours. After the passage of 100 hours, the recorded signal was reproduced to measure S/N of the magnetic disk. As a result, a reproduction output of 22.5 dB was obtained. That is, the rate of decrease of the recording signal in the environment described above was 10%. Therefore, it is appreciated that the magnetic recording apparatus provided with the magnetic disk of the present invention is excellent in recording stability.

### THIRD EMBODIMENT

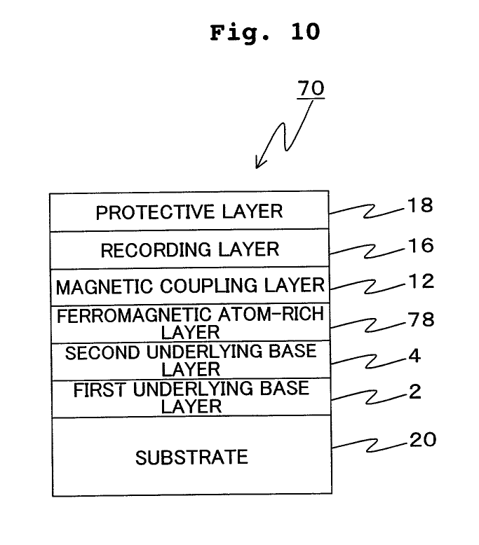

A schematic arrangement of another specified embodiment of the magnetic recording medium according to the present invention is shown in FIG. 10. The magnetic recording medium 70 comprises, on a glass substrate 20, a first underlying base layer 2, a second underlying base layer 4, a ferromagnetic atom-rich layer 78, a magnetic coupling layer (non-magnetic layer) 12, a recording layer 16, and a protective layer 18. The respective layers were formed as follows by means of sputtering by using a DC magnetron sputtering apparatus.

At first, a glass substrate having a diameter of 2.5 inches (6.25 cm) was charged into a preparatory chamber of the DC magnetron sputtering apparatus. The pressure of the preparatory chamber was reduced so that the degree of vacuum was 1×10⁻⁵ Pa. After that, the glass substrate was heated at 200° C. for 10 minutes in order to remove any water from the surface of the glass substrate. Subsequently, the glass substrate was transported from the preparatory chamber to a film formation chamber having a degree of vacuum of 1×10⁻⁵ Pa. The glass substrate was heated to 340° C. in the film formation chamber.

An NiAl film was formed as the first metal underlying base layer 2 on the heated glass substrate 20. An NiAl alloy having Ni:Al=50:50 in atomic ratio was used for a target. The NiAl film had a film thickness of 50 nm. The Ar gas pressure during the sputtering was 0.3 Pa, and the introduced electric power was 500 W.

A CrMo film was formed as the second metal underlying base layer 4 to have a film thickness of 20 nm on the first metal underlying base layer 2. A CrMo alloy containing Mo by 27 atomic % was used for a target. The film formation condition was the same as that for the first metal underlying base layer 2.

Subsequently, a CoPt film was formed as the ferromagnetic atom-rich layer 78 to have a film thickness of 2 nm on the second metal underlying base layer. A CoPt alloy containing Pt by 17 atomic % was used for a target. The film formation condition during the sputtering was the same as that for the first metal underlying base layer 2 except that the introduced electric power was 100 W, and the spacing distance between the substrate and the target was lengthened.

Subsequently, an Ru film was formed as the magnetic coupling layer 12 to have a film thickness of 0.8 nm on the ferromagnetic atom-rich layer 78. Ru was used for a target. The film formation condition during the sputtering was the same as that for the ferromagnetic atom-rich layer 78.

A CoCrPtB film having magnetization in the in-plane direction was formed as the recording layer 16 to have a film thickness of 18 nm on the magnetic coupling layer. A Co₆₄Cr₂₀Pt₁₂B₄ alloy was used for a target. The film formation condition was the same as that for the first metal underlying base layer 2.

Finally, a carbon layer was formed as the protective film to have a film thickness of 5 nm on the recording layer 16 of CoCrPtB. The film formation condition was the same as that for the first metal underlying base layer 2. Thus, the magnetic disk 70 having the structure shown in FIG. 10 was produced.

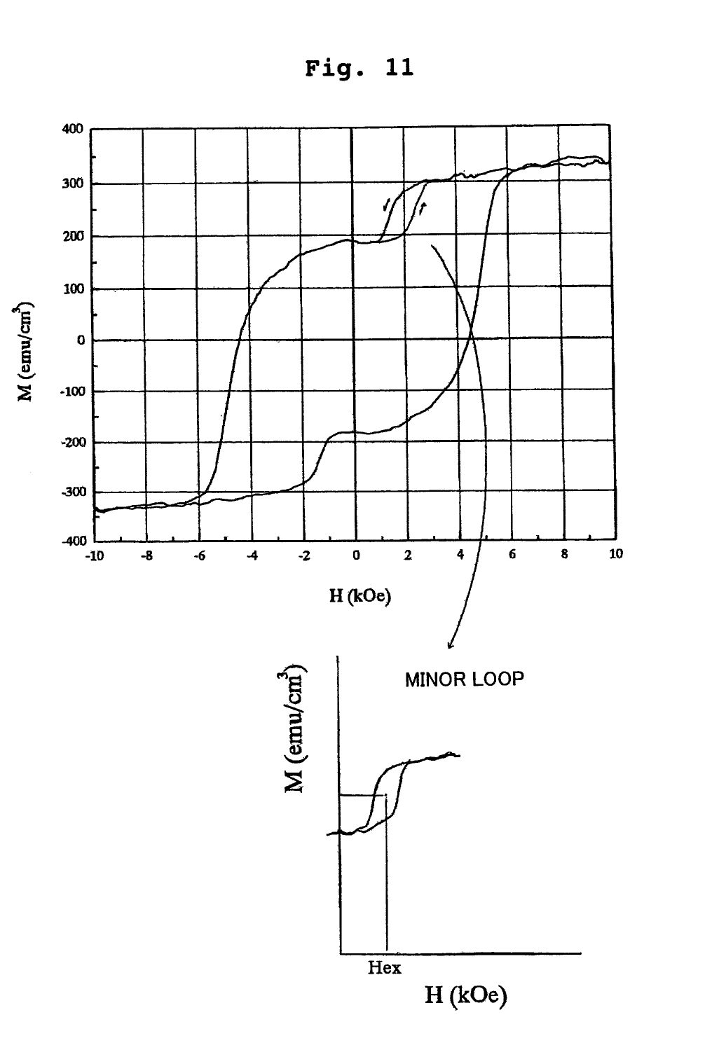

The magnetic field was applied to the magnetic disk obtained as described above with VSM in the same manner as in the first embodiment to observe the magnetization curve with respect to the external magnetic field. An obtained result is shown in FIG. 11. As understood from the hysteresis loop, in the same manner as in the magnetic disk produced in the first embodiment, an area also existed in the magnetic disk produced in this embodiment, in which the magnetization is suddenly lowered before the external magnetic field is zero when the external magnetic field is lowered after the external magnetic field in the positive direction is applied to saturate the magnetization. As appreciated from FIG. 11, the magnetization curve depicts a minor loop which exhibits hysteresis in this area. A magnified view of the minor loop is shown in the lower part of FIG. 11. The exchange coupling magnetic field Hₑₓ was determined from the minor loop, in the same manner as in the magnetic disk produced in the first embodiment. As a result, the exchange coupling magnetic field Hₑₓ was 1.7 kOe.

Subsequently, a plurality of magnetic disks were produced in accordance with the same process as that described above. A lubricant was applied onto the protective layers of the respective magnetic disks. After that, the magnetic disks were incorporated into the magnetic recording apparatus shown in FIGS. 8 and 9, in the same manner as in the second embodiment. A signal was recorded on the magnetic disk in the same manner as in the second embodiment by using the magnetic recording apparatus to evaluate S/N of the magnetic disk. As a result, a reproduction output of 25 dB was obtained.

Subsequently, in order to evaluate the recording stability of the magnetic recording apparatus as described above, the magnetic recording apparatus was placed in an environment at 80° C. at a humidity of 80% for 100 hours, in the same manner as in the second embodiment. After the passage of 100 hours, the recorded signal was reproduced to measure S/N of the magnetic disk. As a result, a reproduction output of 24.5 dB was obtained. That is, the rate of decrease of the recording signal in the environment described above was 2%. Therefore, according to the comparison with the magnetic recording apparatus of Comparative Example 2, it is understood that the magnetic recording apparatus provided with the magnetic disk of the present invention is excellent in recording stability.

### THIRD MODIFIED EMBODIMENT

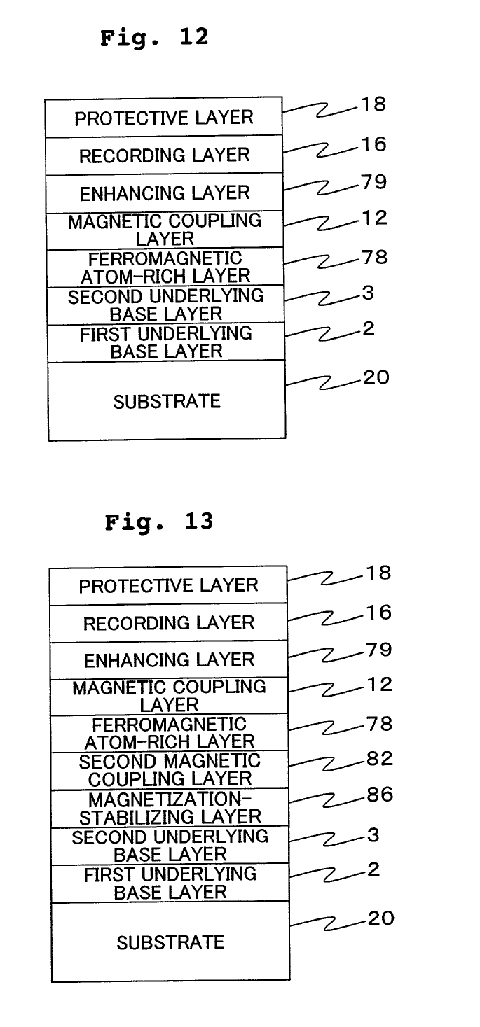

As a modified embodiment of the magnetic disk produced in the third embodiment, an enhancing layer 79 may be provided at the interface between the magnetic coupling layer 12 and the recording layer 16 as shown in FIG. 12. The enhancing layer 79 may be formed by using the same material as that for the enhancing layer 8 of the magnetic disk produced in the first embodiment. The enhancing layer 79 functions to increase the exchange coupling between the recording layer 16 and the ferromagnetic atom-rich layer 78.

### FOURTH MODIFIED EMBODIMENT

As another modified embodiment of the magnetic disk produced in the third embodiment, a magnetization-stabilizing layer 86 and a second magnetic coupling layer 82 may be provided on the second underlying base layer 3 in order to further stabilize the magnetization of the recording layer 16 as shown in FIG. 13. The magnetization-stabilizing layer 86 may be formed by using the same material as that for the magnetization-stabilizing layer 6 of the magnetic disk produced in the first embodiment. Ru may be used for the second magnetic coupling layer 82 in the same manner as in the third embodiment. As still another modified embodiment, the magnetic disk shown in FIG. 13 may be constructed by substituting the magnetization-stabilizing layer 86 with the enhancing layer used in the first embodiment.

### FOURTH EMBDODIMENT

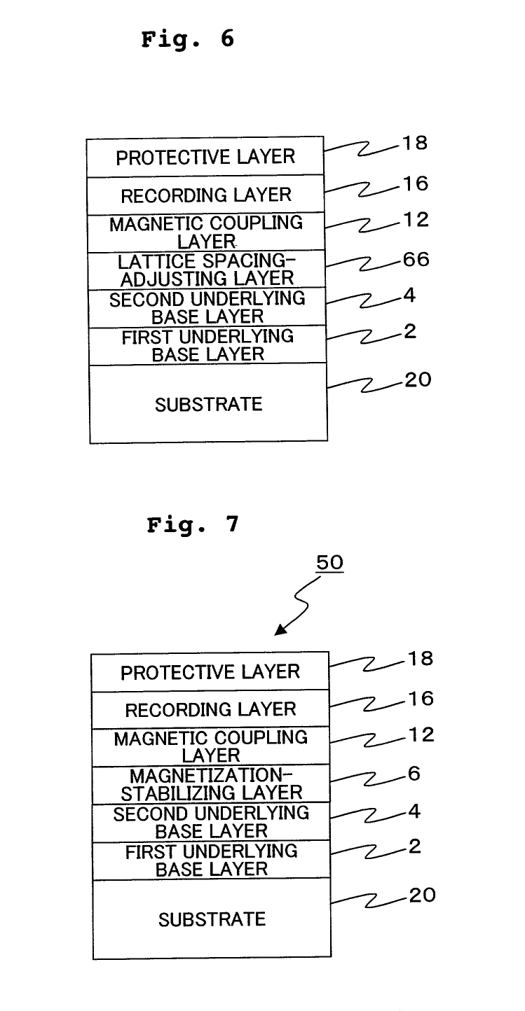

In this embodiment, explanation will be made for still another preferred specified embodiment of the magnetic recording medium. In this embodiment, a magnetic recording medium was produced, in which the ferromagnetic atom-rich layer of the magnetic disk having the structure shown in FIG. 10 produced in the third embodiment was changed to a lattice spacing-adjusting layer. That is, as shown in FIG. 6, the magnetic disk was produced, comprising, on a glass substrate 20, a first underlying base layer 2, a second underlying base layer 4, a lattice spacing-adjusting layer 66, a magnetic coupling layer 12, a recording layer 16, and a protective layer 18. In this embodiment, the same magnetic material as that for the ferromagnetic atom-rich layer 78 of the magnetic disk produced in the third embodiment was used for the lattice spacing-adjusting layer 66. In the third embodiment, the ferromagnetic atom-rich layer 78 was formed as the film w while the spacing distance between the substrate and the target was lengthened. However, in this embodiment, the lattice spacing-adjusting layer 66 was formed as a film while the spacing distance between the substrate and the target was not lengthened. The magnetic coupling layer 12 was formed as a film in the same manner as in the third embodiment except that the spacing distance between the substrate and the target was lengthened. The layers other than the lattice spacing-adjusting layer 66 and the magnetic coupling layer 12 were formed as films in accordance with the same method as that used in the third embodiment.

As Comparative Example 3, a magnetic disk, which was similar to the magnetic disk shown in FIG. 6, was produced by forming a CoCrPtB film having the same composition as that of the recording layer 10 in place of the lattice spacing-adjusting layer 66. The CoCrPtB film had a film thickness of 4.5 nm, and the recording layer had a film thickness of 18 nm, in the same manner as described above.

### EVALUATION OF MAGNETIZATION CURVE

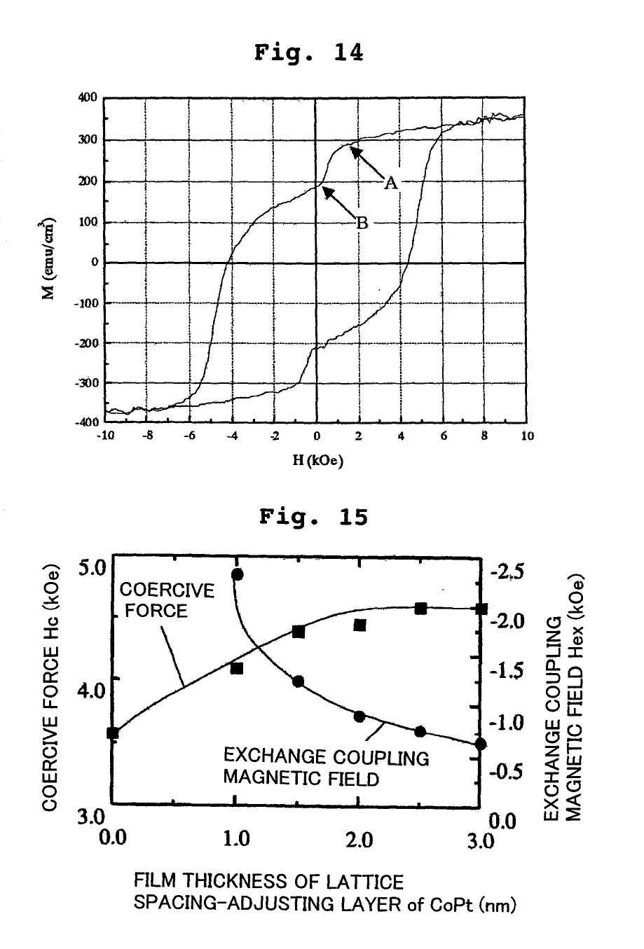

The magnetization was measured as follows for the magnetic disk of this embodiment and the magnetic disk of Comparative Example 3. The magnetic field was applied with VSM (Vibration Sample Magnetometer) to observe the magnetization curve with respect to the external magnetic field. An obtained result is shown in FIG. 14. As appreciated from a hysteresis loop shown in FIG. 14, an area exists, in which the magnetization is suddenly lowered at a certain magnetic field before the external magnetic field is zero when the external magnetic field is lowered after the external magnetic field in the positive direction is applied to saturate the magnetization. This phenomenon is caused by the influence of the exchange coupling exerted between the recording layer and the lattice spacing-adjusting layer. This phenomenon appears as follows. That is, when the magnetization of the magnetic recording medium is saturated, the magnetization of the recording layer is parallel to the magnetization of the lattice spacing-adjusting layer. However, when the external magnetic field is lowered, then the magnetization of the lattice spacing-adjusting layer is inverted to be antiparallel to the direction of magnetization of the recording layer, thereby causing this phenomenon.

The coercive force of the recording layer was determined from the hysteresis loop shown in FIG. 14. The way of determining the coercive force will be explained below. The hysteresis loop shown in FIG. 14 is the hysteresis loop of the magnetic recording medium. The value of magnetization on the hysteresis loop indicates the sum of magnetizations of the recording layer and the lattice spacing-adjusting layer constructed with the magnetic materials respectively. On the other hand, the coercive force of the recording layer is usually defined by the magnitude of the external magnetic field to be obtained when the magnitude of magnetization of the recording layer is zero in the hysteresis loop depicted by only the magnetization of the recording layer. Accordingly, the coercive force of the recording layer was estimated as follows from the hysteresis loop shown in FIG. 14. As for the hysteresis loop shown in FIG. 14, it is assumed that only the magnetization of the lattice spacing-adjusting layer is detected when the magnetization of the recording layer is zero. It is assumed that the magnitude of the magnetization of the lattice spacing-adjusting layer in this case is Mₛₜₐ. On this assumption, the magnitude of the external magnetic field, at which the magnetization of −Mₛₜₐ is obtained in the hysteresis loop shown in FIG. 14, indicates the external magnetic field to be obtained when the magnetization of the recording layer is zero, i.e., the coercive force of the recording layer. Mₛₜₐ can be estimated as follows from the hysteresis loop shown in FIG. 14.

As described above, in the hysteresis loop shown in FIG. 14, the magnetization is suddenly decreased between Point A and Point B on the loop as shown in FIG. 14, when the external magnetic field is lowered after the external magnetic field in the positive direction is applied to saturate the magnetization. The sudden decrease in magnetization between Point A and Point B is caused such that only the magnetization of the lattice spacing-adjusting layer is inverted without any change of the direction of magnetization of the recording layer. The direction of magnetization of the recording layer is parallel to that of the lattice spacing-adjusting layer at Point A on the loop. The magnetization at Point A represents the sum of magnetizations of the recording layer and the lattice spacing-adjusting layer. On the other hand, the directions of magnetization of the respective layers are antiparallel at Point B. Accordingly, the magnetization at Point B represents the difference in magnetization between the recording layer and the lattice spacing-adjusting layer. Therefore, the magnetization Mₛₜₐ of the lattice spacing-adjusting layer described above can be estimated as a half of the difference between the value of magnetization at Point A and the value of magnetization at Point B on the loop.

The coercive force of the recording layer was determined from the hysteresis loop shown in FIG. 14 in accordance with the method as described above. As a result, the coercive force was about 4.5 kOe. On the other hand, the coercive force was determined in accordance with the same method for the recording layer of the magnetic disk of Comparative Example 3. As a result, the coercive force of the recording layer was about 3.5 kOe. That is, the coercive force of the recording layer of the magnetic disk of this embodiment was increased by about 30% as compared with the recording layer of the magnetic disk of Comparative Example 3.

The relation of orientation between the second underlying base layer 4 and the recording layer 10 resides in CrMo(211)[110]//CoCrPtB(10·0)[0001]. The lattice spacing of CrMo[110] as the second underlying base layer 4 is 4.182 angstroms, the lattice spacing of [0001] of CoPt used as the lattice spacing-adjusting layer 6 in this embodiment is 4.178 angstroms, and the lattice spacing of CoCrPtB used as the recording layer 10 is 4.159 angstroms. When the mismatch Δ1 in lattice spacing between the recording layer 10 and the second underlying base layer 4, and the mismatch Δ2 in lattice spacing between the lattice spacing-adjusting layer 6 and the second underlying base layer 4 are determined from the expression (1) described above, there are given Δ1=0.550% and Δ2=0.096%, in which Δ1>Δ2 is satisfied. on the other hand, in the case of the magnetic disk of Comparative Example, both of the recording layer and the lattice spacing-adjusting layer are composed of CoCrPtB having the same composition, in which there is given for the mismatch Δ1=Δ2=0.550%. Therefore, when the lattice spacing-adjusting layer is formed as the film on CrMo as the second underlying base layer, the mismatch in lattice spacing between the underlying base layer and the recording layer can be decreased when CoPt is used for the lattice spacing-adjusting layer as compared with the case in which CoCrPtB is used. Therefore, it is possible to improve the crystallinity of the recording layer.

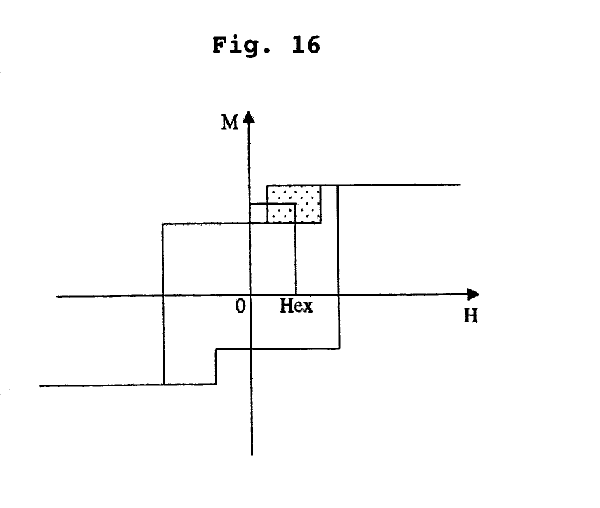

In the hysteresis loop shown in FIG. 14, in the area in which the magnetization is suddenly lowered before the magnetic field is zero, a point appears, at which the rate of change of magnetization with respect to the external magnetic field (δM/δH) is locally maximized. When the magnetic field is lowered after the appearance of the local maximum point, and the external magnetic field is increased again after the rate of change of the magnetization is stabilized, then a hysteresis curve is obtained as depicted with hatched area in FIG. 16. The hysteresis curve is called “minor loop”. The magnetic field H, which is located at the center of the loop disposed at the midpoint between the upper end and the lower end of the minor loop, is known as the exchange coupling magnetic field Hex which is proportional to the exchange coupling between the recording layer 10 and the lattice spacing-adjusting layer 6. In the case of the magnetic disk obtained in this embodiment, it has been revealed that Hex is about 1.0 kOe. On the other hand, in the case of the magnetic disk of Comparative Example 3, it has been revealed that Hex determined from a minor loop is 0.4 kOe. Therefore, in the present invention, the exchange coupling force between the lattice spacing-adjusting layer and the recording layer is increased by increasing the ratio of the magnetic element in the lattice spacing-adjusting layer as compared with the recording layer.

Next, as for the magnetic disks of the present invention and Comparative Example 3, the value (Ku·V)/(k_{B}·T) (Ku represents the crystalline magnetic anisotropy constant of the recording layer, V represents the volume of activation, k_{B} represents the Boltzmann's constant, and T represents the absolute temperature) was determined as the index for the thermal stability of the magnetic disk. As a result, the value was about 78 in the case of the magnetic disk of the embodiment of the present invention. On the other hand, the value was about 65 in the case of the magnetic recording medium of Comparative Example 3. Also according to this fact, it is understood that the magnetic recording medium of the present invention is excellent in thermal stability. Further, in the case of the magnetic disk of the embodiment of the present invention, Brt as the index to exhibit the possibility of high density recording on the in-plane magnetic recording medium was about 49.7 Gμm.

Next, magnetic disks were produced in accordance with the same process as described above except that lattice spacing-adjusting layers were formed with various film thicknesses to obtain a plurality of magnetic disks having different film thicknesses of the lattice spacing-adjusting layers. The magnetization curve was observed to determine the coercive force of the recording layer by means of VSM in the same manner as described above for each of the magnetic disks. FIG. 15 shows a relationship between the film thickness of the CoPt layer as the lattice spacing-adjusting layer and the coercive force of the recording layer. As appreciated from this result, the coercive force of the recording layer is increased as the film thickness of the CoPt film is increased.

Subsequently, the exchange coupling magnetic field was determined in accordance with the same method as described above to determine the dependency of the exchange coupling magnetic field with respect to the film thickness of the lattice spacing-adjusting layer for the respective magnetic disks in which the film thickness of the lattice spacing-adjusting layer differed. An obtained result is shown in a graph in FIG. 15. As understood from this graph, the exchange coupling magnetic field is decreased, as the film thickness of the lattice spacing-adjusting layer is increased. According to FIG. 15, it is understood that when the lattice spacing-adjusting layer is formed of the CoPt layer, the optimum film thickness of the lattice spacing-adjusting layer, which makes it possible to increase both of the exchange coupling magnetic field and the coercive force of the recording layer in a well-balanced manner, is 1.0 nm to 2.0 nm.

### FIFTH EMBODIMENT

In this embodiment, three types of magnetic disks, in which the concentration of the ferromagnetic atom of the first enhancing layer differed, were produced in the same manner as in the first embodiment except that both of the ferromagnetic materials for forming the first enhancing layer (ferromagnetic atom-rich layer) and the second enhancing layer were changed to Co₆₂Cr₂₂Pt₁₂B₄, Co₆₄Cr₂₀Pt₁₂B₄, and Co₈₃Cr₁₇. That is, the ferromagnetic atom concentrations of the first enhancing layer and the second enhancing layer contacting with the Ru layer (magnetic coupling layer) were changed to 62%, 64%, and 83%. The exchange coupling energy J between the recording layer and the first enhancing layer was investigated for the three types of the magnetic disks with the different ferromagnetic atom concentrations in the first enhancing layer obtained as described above and the magnetic disk produced in the first embodiment (ferromagnetic atom concentrations of the first and second enhancing layers were 10%). The exchange coupling energy J was determined according to the following expression (2).

J=Hₑₓ×(Ms×t+Ms_{E}×t_{E}) (2)

In the expression (2), Hₑₓ represents the exchange coupling magnetic field indicating the exchange coupling of magnetization between the recording layer and the magnetization-stabilizing layer, Ms and Ms_{E} indicate the saturation magnetizations of the magnetization-stabilizing layer and the first enhancing layer respectively, and t and t_{E} indicate the film thicknesses of the magnetization-stabilizing layer and the first enhancing layer respectively. The exchange coupling magnetic field Hₑₓ was determined in accordance with the same method as the method described in the first embodiment.

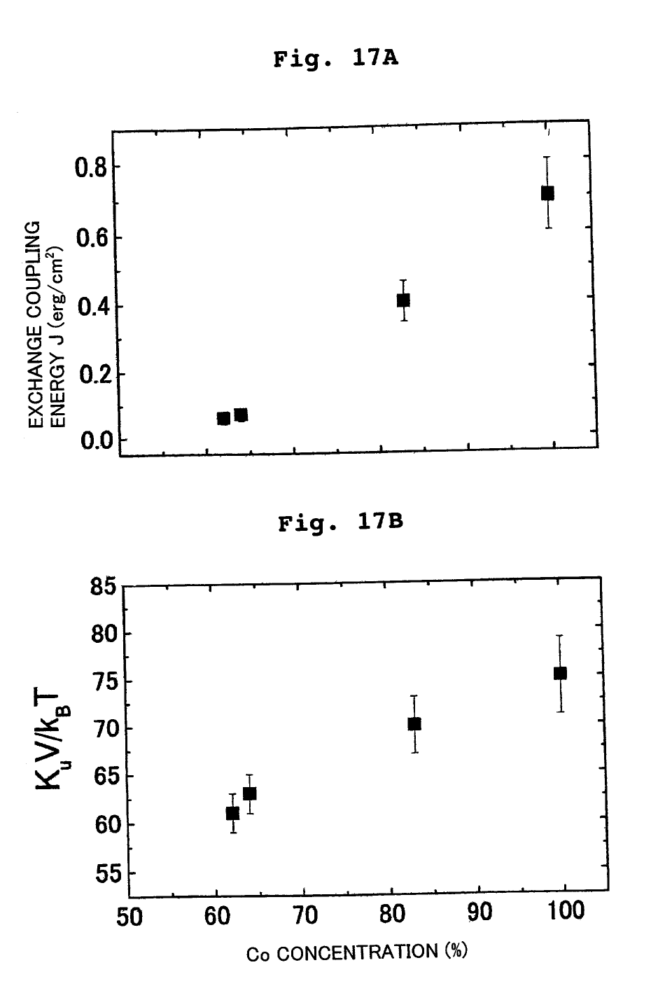

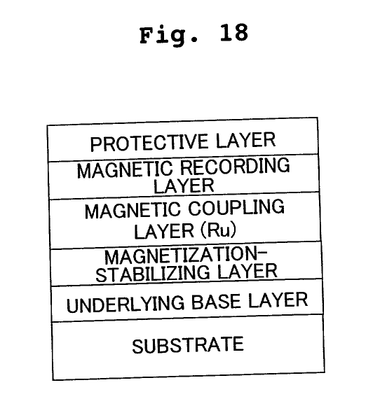

FIG. 17A shows the change of the exchange coupling energy with respect to the Co concentration of the first enhancing layer. As shown in FIG. 17A, it is understood that the exchange coupling energy between the recording layer and the magnetization-stabilizing layer is increased, as the ferromagnetic atom concentration (Co concentration) of the first enhancing layer is increased. The exchange coupling energy is increased about five times in the magnetic recording medium in which the ferromagnetic atom (Co) concentration of the first enhancing layer is not less than 83%, as compared with the magnetic recording medium in which the ferromagnetic atom (Co) concentration of the first enhancing layer is 64% (magnetic recording medium in which the ferromagnetic atom concentration of the first enhancing layer is equal to that of the recording layer). That is, the exchange coupling energy was successfully increased about five times by increasing the ferromagnetic atom concentration of the first enhancing layer by not less than 19% in absolute value (about 30% in relative value with respect to the ferromagnetic atom concentration of the recording layer) as compared with the ferromagnetic atom concentration of the recording layer. The exchange coupling energy was further increased when the ferromagnetic atom concentration of the first enhancing layer was 100%, in which the exchange coupling energy was increased about 8.75 times as compared with the magnetic recording medium in which the ferromagnetic atom (Co) concentration of the first enhancing layer was 64%. On the other hand, the exchange coupling energy of the magnetic recording medium, in which the ferromagnetic atom concentration of the first enhancing layer is lower than the ferromagnetic atom concentration of the recording layer, is lower than that of the magnetic recording medium in which the ferromagnetic atom (Co) concentration of the first enhancing layer is 64%, i.e., the magnetic recording medium in which the ferromagnetic atom concentration of the first enhancing layer is equal to that of the recording layer. Further, (Ku·V)/(k_{B}·T) as the index of thermal stability was measured for the respective magnetic recording media. A result of the measurement is shown in FIG. 17B. As appreciated from FIG. 17B, when the ferromagnetic atom concentration of the first enhancing layer is made higher than the ferromagnetic atom concentration of the recording layer, (Ku·V)/(k_{B}·T) is also improved in the same manner as the exchange coupling energy. According to the results as described above, it is possible to obtain the magnetic recording medium which is excellent in thermal stability by increasing the ferromagnetic atom concentration of the first enhancing layer (ferromagnetic atom-rich layer) as compared with the ferromagnetic atom concentration of the recording layer.

### SIXTH EMBODIMENT

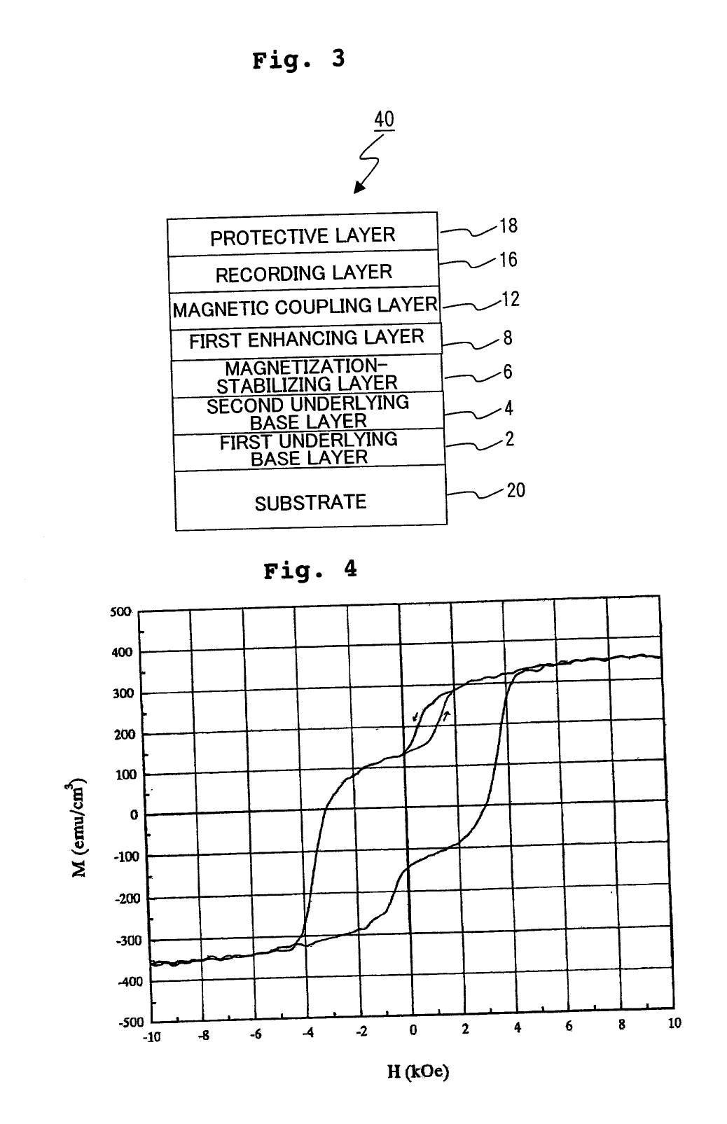

In this embodiment, explanation will be made for still another specified embodiment of the magnetic recording medium of the present invention. FIG. 2 shows a schematic sectional view of a magnetic recording medium of this embodiment. The magnetic recording medium 30 comprises, on a glass substrate 20, a first underlying base layer 2, a second underlying base layer 4, a magnetization-stabilizing layer 6, a magnetic coupling layer 12, a ferromagnetic atom-rich layer (second enhancing layer) 14, a recording layer 16, and a protective layer 18. The magnetic recording medium 30 as described above is successfully produced in the same manner as in the first embodiment except that the second enhancing layer of the magnetic disk having the structure shown in FIG. 1 produced in the first embodiment is used as the ferromagnetic atom-rich layer, and the first enhancing layer is not formed. Further, a modified embodiment of the magnetic recording medium 30 shown in FIG. 2 is available. That is, a second magnetization-stabilizing layer, a second magnetic coupling layer, and a fourth enhancing layer may be further added between the ferromagnetic atom-rich layer (second enhancing layer) 14 and the recording layer 16.

In the foregoing, the present invention has been specifically explained with reference to the embodiments. For example, the first embodiment is an example to embody the first or third aspect of the present invention. However, the present invention is not limited thereto. The substrate, the first metal underlying base layer, the second metal underlying base layer, the ferromagnetic atom-rich layer, the lattice spacing-adjusting layer, the magnetization-stabilizing layer, the magnetic coupling layer, the first enhancing layer, the second enhancing layer, and the recording layer may be constructed with a variety of known materials without being limited to the materials described in the embodiments.

In the magnetic recording medium according to the first aspect of the present invention, the strong exchange coupling force is generated between the recording layer and the ferromagnetic atom-rich layer owing to the ferromagnetic atom-rich layer which is formed of the ferromagnetic material having the high ferromagnetic atom concentration as compared with the ferromagnetic material for forming the recording layer. Accordingly, the magnetic recording medium is excellent in thermal stability. Therefore, even when the minute magnetic domains are formed for the high density recording, then the thermal fluctuation scarcely occurs, and it is possible to stably retain the recorded information over a long period of time.

In the magnetic recording medium according to the second aspect of the present invention, the crystalline orientation of the recording layer is improved owing to the lattice spacing-adjusting layer having the lattice spacing so that the mismatch in lattice spacing between the underlying base layer and the recording layer is mitigated. Therefore, the coercive force of the recording layer is increased. Accordingly, minute magnetic domains can be formed in the recording layer, and it is possible to realize further advanced high density recording. Further, the exchange coupling force between the lattice spacing-adjusting layer and the recording layer can be increased by increasing the ratio of the magnetic element in the lattice spacing-adjusting layer as compared with the recording layer. The magnetic recording medium as described above is excellent in thermal stability, and it has the high coercive force. Therefore, it is possible to perform the super high density recording on the magnetic recording medium.

In the magnetic recording medium according to the third aspect of the present invention, the exchange coupling force between the recording layer and the magnetization-stabilizing layer is increased owing to the ferromagnetic atom-rich layer. Therefore, in the same manner as the magnetic recording medium according to the first aspect, the magnetic recording medium according to the third aspect is excellent in thermal stability. Even when the minute magnetic domains are formed for the high density recording, then the thermal fluctuation scarcely occurs, and it is possible to stably retain the recorded information over a long period of time.

The magnetic recording apparatus, which is provided with the magnetic recording medium according to the first, second, or third aspect of the present invention, is excellent in recording stability. It is possible to realize the super high density recording exceeding, for example, 40 Gbits/inch² (6.20 Gbits/cm²).

What is claimed is:

1. A magnetic recording medium comprising:
a recording layer which is formed of a ferromagnetic material;
a ferromagnetic atom-rich layer which is formed of a ferromagnetic material having a high ferromagnetic atom concentration as compared with the ferromagnetic material for forming the recording layer; and
a non-magnetic layer which exists between the recording layer and the ferromagnetic atom-rich layer.

2. The magnetic recording medium according to claim 1, wherein the ferromagnetic atom-rich layer is formed of one selected from the group consisting of Co, Ni, Fe, and CoNiFe alloy.

3. The magnetic recording medium according to claim 1, wherein the ferromagnetic atom-rich layer is formed of an alloy of a transition metal and one selected from the group consisting of Co, Ni, and Fe.

4. The magnetic recording medium according to claim 1, further comprising a magnetization-stabilizing layer which stabilizes magnetization of the recording layer, wherein the ferromagnetic atom-rich layer is positioned between the magnetization-stabilizing layer and the recording layer, and the ferromagnetic atom-rich layer functions as a first enhancing layer which increases exchange coupling between the magnetization-stabilizing layer and the recording layer.

5. The magnetic recording medium according to claim 4, further comprising a second enhancing layer which increases exchange coupling between the recording layer and the ferromagnetic atom-rich layer, the second enhancing layer being disposed between the recording layer and the non-magnetic layer.

6. The magnetic recording medium according to claim 4, wherein the recording layer is formed of a material containing Co, Ni, or Fe, and the first enhancing layer is formed of a material containing Co, Ni, or Fe at a concentration higher than a concentration in the recording layer.

7. The magnetic recording medium according to claim 6, wherein the recording layer contains Boron.

8. The magnetic recording medium according to claim 4, wherein the enhancing layer has a film thickness of 0.2 to 2 nm.

9. The magnetic recording medium according to claim 1, wherein the non-magnetic layer is formed of Ru.

10. The magnetic recording medium according to claim 4, wherein the magnetization-stabilizing layer includes a first magnetization-stabilizing layer and a second magnetization-stabilizing layer, a second non-magnetic layer is provided between the first magnetization-stabilizing layer and the second magnetization-stabilizing layer, and an auxiliary enhancing layer, which increases exchange coupling between the first magnetization-stabilizing layer and the second magnetization-stabilizing layer, is provided at least at one of positions between the first magnetization-stabilizing layer and the second non-magnetic layer and between the second non-magnetic layer and the second magnetization-stabilizing layer.

11. The magnetic recording medium according to claim 10, wherein the auxiliary enhancing layer includes a first auxiliary enhancing layer which is formed between the first magnetization-stabilizing layer and the second non-magnetic layer, and a second ferromagnetic atom-rich layer which is formed between the second non-magnetic layer and the second magnetization-stabilizing layer.

12. The magnetic recording medium according to claim 1, further comprising a substrate, a second non-magnetic layer, and a magnetization-stabilizing layer which is positioned therebetween, which is formed of a ferromagnetic material, and which stabilizes magnetization of the recording layer, wherein the ferromagnetic atom-rich layer is positioned on a side opposite to the substrate with respect to the second non-magnetic layer.

13. The magnetic recording medium according to claim 1, further comprising a substrate, a second non-magnetic layer, and a second ferromagnetic atom-rich layer which is positioned therebetween, wherein the ferromagnetic atom-rich layer is positioned on a side opposite to the substrate with respect to the second non-magnetic layer.

14. A magnetic recording medium comprising:
an underlying base layer;
a recording layer which is formed of a ferromagnetic material;
a lattice spacing-adjusting layer which exists between the underlying base layer and the recording layer while making contact with the underlying base layer, which is formed of a ferromagnetic material, and which is provided to adjust lattice spacing for the underlying base layer and the recording layer; and
a non-magnetic layer which exists between the recording layer and the lattice spacing-adjusting layer, wherein:
a difference between lattice spacing on an orientation plane of the lattice spacing-adjusting layer and lattice spacing on an orientation plane of the underlying base layer is smaller than a difference between lattice spacing on an orientation plane of the recording layer and the lattice spacing on the orientation plane of the underlying base layer.

15. The magnetic recording medium according to claim 14, wherein the following relationship is satisfied:
Δ1>Δ2
provided that the lattice spacing on the orientation plane of the recording layer is defined as a₁, the lattice spacing on the orientation plane of the lattice spacing-adjusting layer is defined as a₂, the lattice spacing on the orientation plane of the underlying base layer is defined as a₃, and mismatches Δ1, Δ2 are defined as follows respectively:
Δ1=|(a₁−a₃)/a₃|×100
Δ2=|(a₂−a₃)/a₃|×100.

16. The magnetic recording medium according to claim 15, wherein the mismatches Δ1, Δ2 further satisfy the following relationships:
Δ2<Δ1<10.25; and
(5/10.25)<(Δ1/Δ2)<1.

17. The magnetic recording medium according to claim 14, wherein the lattice spacing-adjusting layer has the same crystal structure as that of the recording layer.

18. The magnetic recording medium according to claim 14, wherein a ratio of magnetic atom contained in the lattice spacing-adjusting layer is larger than a ratio of magnetic atom contained in the recording layer.

19. The magnetic recording medium according to claim 18, wherein a relationship of Ms1>Ms2 is satisfied provided that saturation magnetization of the lattice spacing-adjusting layer is represented by Ms1, and saturation magnetization of the recording layer is represented by Ms2.

20. The magnetic recording medium according to claim 14, wherein the lattice spacing-adjusting layer is formed of one selected from the group consisting of Co, Ni, Fe, and CoNiFe alloy.

21. The magnetic recording medium according to claim 14, wherein the lattice spacing-adjusting layer is formed of an alloy containing a transition metal and one selected from the group consisting of Co, Ni, and Fe.

22. The magnetic recording medium according to claim 14, wherein the non-magnetic layer is formed of Ru.

23. The magnetic recording medium according to claim 14, wherein the lattice spacing-adjusting layer also functions as a layer which stabilizes magnetization of the recording layer and which increases coercive force of the recording layer.

24. The magnetic recording medium according to claim 1, wherein the recording layer has magnetization in an in-plane direction.

25. The magnetic recording medium according to claim 14, wherein the recording layer has magnetization in an in-plane direction.

26. The magnetic recording medium according to claim 1, wherein a magnetization curve of the magnetic recording medium with respect to an external magnetic field exhibits a hysteresis loop, a point, at which a rate of change of magnetization with respect to the external magnetic field exhibits a local maximum when the external magnetic field is lowered after magnetization is saturated, exists in a positive area of the external magnetic field, and an exchange coupling magnetic field, which is determined from the magnetization curve, is not less than 1 kOe.

27. The magnetic recording medium according to claim 14, wherein a magnetization curve of the magnetic recording medium with respect to an external magnetic field exhibits a hysteresis loop, a point, at which a rate of change of magnetization with respect to the external magnetic field exhibits a local maximum when the external magnetic field is lowered after magnetization is saturated, exists in a positive area of the external magnetic field, and an exchange coupling magnetic field, which is determined from the magnetization curve, is not less than 1 kOe.

28. A magnetic recording medium comprising:
a recording layer which is formed of a ferromagnetic material;
a magnetization-stabilizing layer which is formed of a ferromagnetic material and which stabilizes magnetization of the recording layer;
a non-magnetic layer which exists between the recording layer and the magnetization-stabilizing layer; and
a ferromagnetic atom-rich layer which exists at least at one of positions between the non-magnetic layer and the recording layer and between the non-magnetic layer and the magnetization-stabilizing layer and which is formed of a ferromagnetic material having a ferromagnetic atom concentration higher than that of the ferromagnetic material for forming the recording layer.

29. A magnetic recording apparatus comprising:
a magnetic recording medium;
a magnetic head which is used to record or reproduce information on the magnetic recording medium; and
a driving unit which drives the magnetic recording medium with respect to the magnetic head, wherein the magnetic recording medium comprises:
a recording layer which is formed of a ferromagnetic material;
a ferromagnetic atom-rich layer which is formed of a ferromagnetic material having a high ferromagnetic atom concentration as compared with the ferromagnetic material for forming the recording layer; and
a non-magnetic layer which exists between the recording layer and the ferromagnetic atom-rich layer.

30. A magnetic recording apparatus comprising:
a magnetic recording medium;
a magnetic head which is used to record or reproduce information on the magnetic recording medium; and
a driving unit which drives the magnetic recording medium with respect to the magnetic head, wherein the magnetic recording medium comprises:
an underlying base layer;
a recording layer which is formed of a ferromagnetic material;
a lattice spacing-adjusting layer which exists between the underlying base layer and the recording layer while making contact with the underlying base layer, which is formed of a ferromagnetic material, and which is provided to adjust lattice spacing for the underlying base layer and the recording layer; and
a non-magnetic layer which exists between the recording layer and the lattice spacing-adjusting layer, wherein:
a difference between lattice spacing on an orientation plane of the lattice spacing-adjusting layer and lattice spacing on an orientation plane of the underlying base layer is smaller than a difference between lattice spacing on an orientation plane of the recording layer and the lattice spacing on the orientation plane of the underlying base layer.

31. A magnetic recording apparatus comprising:
a magnetic recording medium;
a magnetic head which is used to record or reproduce information on the magnetic recording medium; and
a driving unit which drives the magnetic recording medium with respect to the magnetic head, wherein the magnetic recording medium comprises:
a recording layer which is formed of a ferromagnetic material;
a magnetization-stabilizing layer which is formed of a ferromagnetic material and which stabilizes magnetization of the recording layer;
a non-magnetic layer which exists between the recording layer and the magnetization-stabilizing layer; and
a ferromagnetic atom-rich layer which exists at least at one of positions between the non-magnetic layer and the recording layer and between the non-magnetic layer and the magnetization-stabilizing layer and which is formed of a ferromagnetic material having a ferromagnetic atom concentration higher than that of the ferromagnetic material for forming the recording layer.
